(19) United States
(12) Patent Application Publication
(10) Pub. No.: US 2015/0058198 A1
(43) Pub. Date: Feb. 26, 2015

(54) System and Method for Domain Name Currency

(71) Applicant: Minds and Machines, LLC, Santa Monica, CA (US)

(72) Inventor: Frederick R Krueger, Santa Monica, CA (US)

(73) Assignee: Minds and Machines, LLC, Santa Monica, CA (US)

(21) Appl. No.: 13/972,367

(22) Filed: Aug. 21, 2013

(51) Int. Cl. G06Q 20/36; G06Q 20/06

(52) U.S. Cl. CPC G06Q 20/3678; G06Q 20/065
USPC 705/39

(57) ABSTRACT

A system and methods for creating and administering a domain name-based currency, wherein a domain name has an associated currency value for use as a value store and exchange medium.

### FIELD OF THE INVENTION

The present invention relates generally to electronic currencies.

### SUMMARY OF THE INVENTION WITH BACKGROUND

Electronic currencies, such as Beenz, Flooze, and other means of storing value, have been around since the beginning of the Internet. Electronic currencies provide clear advantages over standard online bank accounts. For instance, they offer an easier way to transfer money between parties. However, centrally-managed currencies also have flaws—they require that both parties have accounts at the central issuer of currency; they are more susceptible to hacking as all transactions go through a central point; and they do not provide users with a clear, distributed system to verify value.

The present invention relates to an electronic currency that uses domain names as a store of guaranteed value. In one embodiment of the system described herein, each domain name has a fixed monetary value and can be redeemed by the registry for actual stored value. By transferring the domain name between parties using the existing domain name system, value can be securely and electronically transferred to facilitate commerce.

### BRIEF DESCRIPTION OF THE DRAWINGS

FIG. 1 illustrates a schematic diagram of a system according to the present invention.

FIG. 2 illustrates an example browser representation of a coupon according to the present invention.

FIG. 3 is a flow chart illustrating the steps for a method for creating an administering a currency system according to the present invention.

### DETAILED DESCRIPTION

Generally stated, the present invention is directed to an electronic currency. More specifically, embodiments of the invention are directed toward the use of inherent value in a domain name or Universal Resource Locator (URL) or Universal Resource Identifier (URI). Embodiments accomplish that function by assigning domain names with a guarantee to repurchase that domain name at a given value, whereby different domain names are guaranteed at different value levels. The domain names may also have an associated resource or property that describes the inherent value of the domain name.

Referring now to the several drawings, the illustrations are for the purpose of describing preferred embodiments of the invention and are not intended to limit the invention.

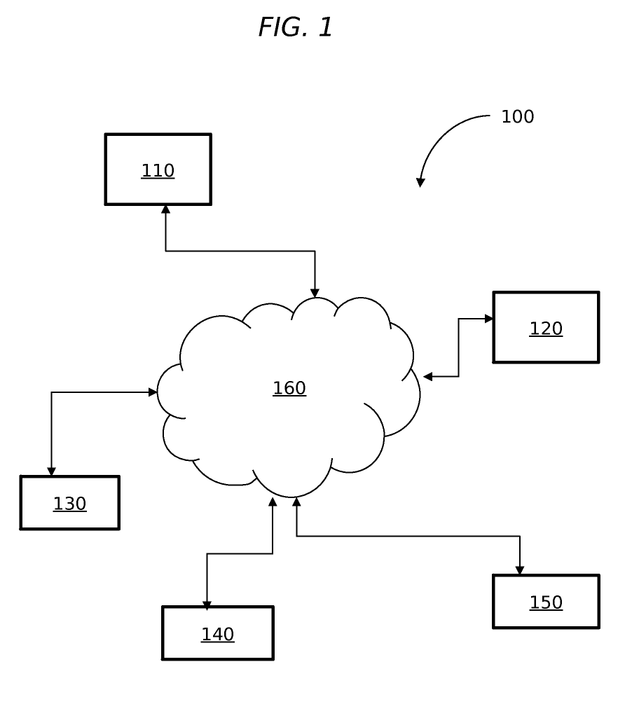

FIG. 1 is a functional block diagram of a one embodiment constructed in accordance with the teachings of the present invention, generally described as system 100. Shown in FIG. 1 are a domain name issuing registry 110, a domain name currency registrar 120, a first user 130, a second user 140, and an n-user 150, all in electronic communication through a network 160.

As the number of top-level domains (TLDs) increases, domain names can be used as a form of currency. Users buy the currency at existing domain name currency registrars, who would in turn buy the names from the issuing registry. The registrars would guarantee the value of the domain name at a fixed point or value and allow redemption at any time for the guaranteed value.

The guaranteed value can be denominated in one of several currencies (dollar, euro, pound, yen, etc.) or in a commodity (ounce of gold, barrel of oil, etc.). When redeemed, the domain would be paid out at the guaranteed value in the currency or commodity of choice.

In a preferred embodiment, the redemption value is available in discreet amounts. For example, some names are worth $1, some $5, some $10, some $20, some $100, some $1,000. In other embodiments, random values could be assigned to a domain.

Participating registrars buy the domains from the registry using standard EPP protocols. The registry also operates a “central registry,” where the domains can be redeemed for the stored value as the commodity or currency in cash, or in the form of a check, wire transfer or other redemption means.

### Buying Guaranteed Domains

End users purchase guaranteed domains in the same way they buy a domain name, but they specify the amount they wish to purchase. For example, a user could specify that they want to purchase a $500 guaranteed domain. The registrar would then issue a domain name, such as USD500-781211.work, which would correspond to that $500.

When typed into the browser system, that domain may resolve to a page showing the guaranteed value of the domain and the registered owner of the e-cash or e-value. Such a result may involve integrating the domain name currency into the domain name system (DNS) servers such that each domain points to a domain value server.

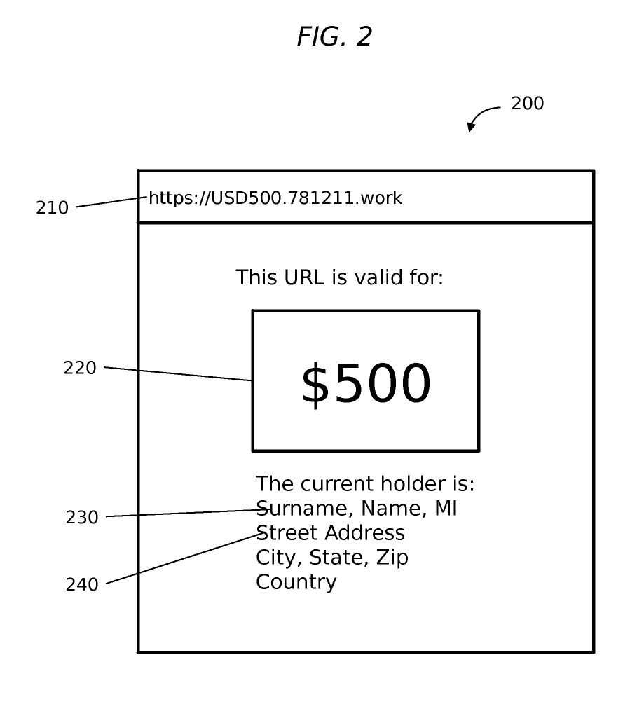

One example of the page to which the domain may resolve is shown in FIG. 2. In this embodiment, the domain name is presented visually in the browser in the representation of a coupon of redeemable value, with the value of the note visible. FIG. 2 is only one example of a browser representation of a coupon according to this specific embodiment, and other representations are possible without deviating from the spirit of the invention.

The coupon 200 includes the domain name 210 and the domain name value 220. Other data that may be included are the domain name owner 230 and the domain name owner's legal address 240.

The Whois system of the DNS can be used to verify ownership of the domain and of its corresponding value; and in one embodiment of the system, this Whois is directly accessible by typing in a CAPTCHA at the domain name address itself.

By prefixing the amount and currency of the domain name, coupled with the guarantee by the participating top-level registry, the name itself becomes a guarantee of authenticity. For example, domain names starting with USD500-XXX would be guaranteed to be reserved for 500 dollar e-value names.

### Transferring Guaranteed Domains to a New Registrar

Transferring guaranteed domains from one registrar to another would operate as transferring any regular domain: an authorization code is created at the releasing registrar and with that “Auth Code,” the receiving registrar can get the name. The value of the domain name is transferred behind the scenes from one registrar to another and, if applicable, from one registrant to another.

### Redeeming Guaranteed Domains

Guaranteed domains could be redeemed at a “central registry” or any participating registrar that implements the redemption EPP protocols. Users, including owner/purchasers of the domains and potential buyers, need not have accounts at the central registry but could participate in the transaction via their preferred domain name registrar.

### Using Guaranteed Domains to Buy Something

Buying something would involve transferring a set of currency domain names from one party to another. Note that the receiving party could “make change” by transferring back some currency domain names to the giving party in the value of the difference between the purchasing currency domain names and the value of the acquired item being purchased.

In a preferred embodiment a user could “make change”, i.e., exchange one or more domains for a different number of domains having equal value by going to the central registrar, or any participating registrar. The registrar may exact a service charge for the exchange.

### Third Party Redemption Agent

As with other fiat currencies, the present system only works if people trust the system. In other words, the currency must be redeemable. This would work more easily, if, for example, a national government stood by the ability to liquidate any holder of a valid domain name. Once people realize that the currency domain names have stable, inherent value and are redeemable, they would gain the trust of the people.

### Use of the Domain Name System

There are advantages of the present system over a central web service, such as an online bank:

(1) With the present invention, the registered owner of the guaranteed domain could be instantly verified by typing the name into any browser and, perhaps in addition, by entering a CAPTCHA code. For example, if a user wanted to buy a car with currency domain names, the user could provide the seller with a list of the user's currency domain names to prove that the user had the money.

(2) With embodiments of the present invention, the typical “locked” state of a domain name would prevent any hacking or unauthorized transfer. This would provide additional security of the value in the eyes of the currency domain name holder.

(3) By using the value of the coupon in the name of the domain, the value associated with the name could be identified by the name alone. This feature is analogous to imprinting the value of paper money on the bill itself.

(4) The fact that the domain name has a fixed value that cannot be hacked if locked makes it superior to an online bank.

There are thus several novel methods involved with creating and administering the currency.

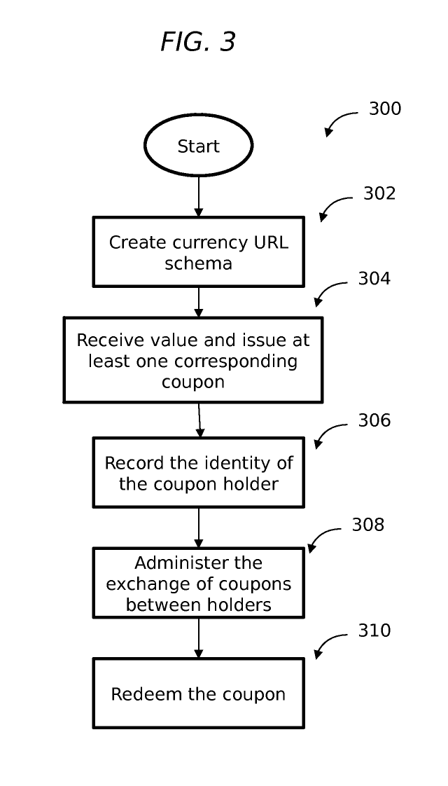

Turning now to FIG. 3, a flowchart is provided that illustrates a method 300 for providing and administering currency domain names. The method includes the steps of: establishing a URL schema for the denominations of a currency (302); receiving value and issuing at least one corresponding currency coupon based on the URL schema (304), recording the identity of the at least one coupon holder (306), and administering the exchange of the at least one coupon between holders (308). A further, optional step includes redeeming the at least one coupon (310).

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

The invention is:

1. A system for establishing an electronic currency, comprising:
a repository of currency domain names wherein each currency domain name is associated with a value, at least two or more currency domain names being associated with a different value, the value of each domain name being evident from the domain name itself; and
a registrar that guarantees the value for each of the currency domain names in the repository of currency domain names, the guarantee comprising an enforceable promise to exchange the value for its associated currency domain name upon request.

2. The system recited in claim 1, further comprising a currency coupon, wherein the currency coupon comprises:
a network-accessible resource to which a given currency domain name points, the resource including an identification of the given currency domain name and a guaranteed value for the currency domain name.

3. The system recited in claim 2, wherein the currency coupon further comprises an identification of an owner of the given currency domain name

4. The system recited in claim 3, wherein the currency coupon further comprises an identification of an address for the owner of the given currency domain name.

5. A method for administering a currency domain name system, comprising:
establishing a URL schema for the denominations of a currency;
receiving value and issuing at least one corresponding currency coupon based on the URL schema;
recording the identity of the at least one coupon holder; and
administering the exchange of the at least one coupon between holders.

6. The method recited in claim 5, further comprising redeeming the at least one coupon.
